(19) United States
(12) Patent Application Publication
(10) Pub. No.: US 2002/0097154 A1
(43) Pub. Date: Jul. 25, 2002

(54) Lofty visual warning devices for walking shoes

(76) Inventor: Todd A. Bland, Omaha, NE (US)

Correspondence Address: Todd A. Bland, 13708 Frederick Avenue, Omaha, NE, 68138, US

(21) Appl. No.: 09/766,410

(22) Filed: Jan. 22, 2001

(51) Int. Cl. G08B 23/00

(52) U.S. Cl. 340/573.1; 340/331

(57) ABSTRACT

For regularly encounterable walking shoes environments typically having a treaded lower-base and an overlying foot-rest surface, disclosed herein are visual warning devices respectively extending loftily vibratorily helically above the foot-rest surface and topically carrying a visually bright ornamental feature. The bright ornamental feature (preferably of bulbous shape) is alternatively provided as: of self-luminescent characteristic; or alternatively, as an electrically-powerable incandescent bulb powerable from a chemical storage-battery that is rearwardly removably attachable to the walking shoe environment.

### BACKGROUND OF THE INVENTION

Toward the quest of augmenting typically encounterable walking shoes with rearwardly positioned visually bright warning means, prior art workers have relegated their quest toward positioning the bright warning means to lowerably restricted positions at the walking shoe lower-base which is oftentimes obscurable to environmental traffic.

### GENERAL OBJECTIVE OF THE INVENTION

To overcome the visually obscure utilitarian deficiencies associated with prior art workers' narrowly-positionably focused efforts to provide effectively warnable encounterability for wearers of typically worn walking shoes.

### GENERAL STATEMENT OF THE INVENTION

With the above mentioned general objective in view, and together with other related and ancillary objectives, which will become more apparent as this description proceeds: the herein “lofty visual warning devices for walking shoes” of the present invention generally comprises: rearwardly attached to the walking shoe lower-base adjacent its rear-end and extending loftily therefrom even above the walking shoe foot-rest surface, one or more lofty visual warning devices respectively comprising a lofty and horizontally vibratory helical column and which respectively topically carry a visually bright ornamental feature, and the latter being selectively alternatively: as an electrically-powerably incandescent bulb from a chemical storage-battery that is removably attached to the walking shoe lower-base; or alternatively, as a self-phosporescent bulbous ornament not requiring external electrical power.

### BRIEF DESCRIPTION OF THE DRAWING

In the drawing, wherein like characters refer to like parts in the several views, and in which:

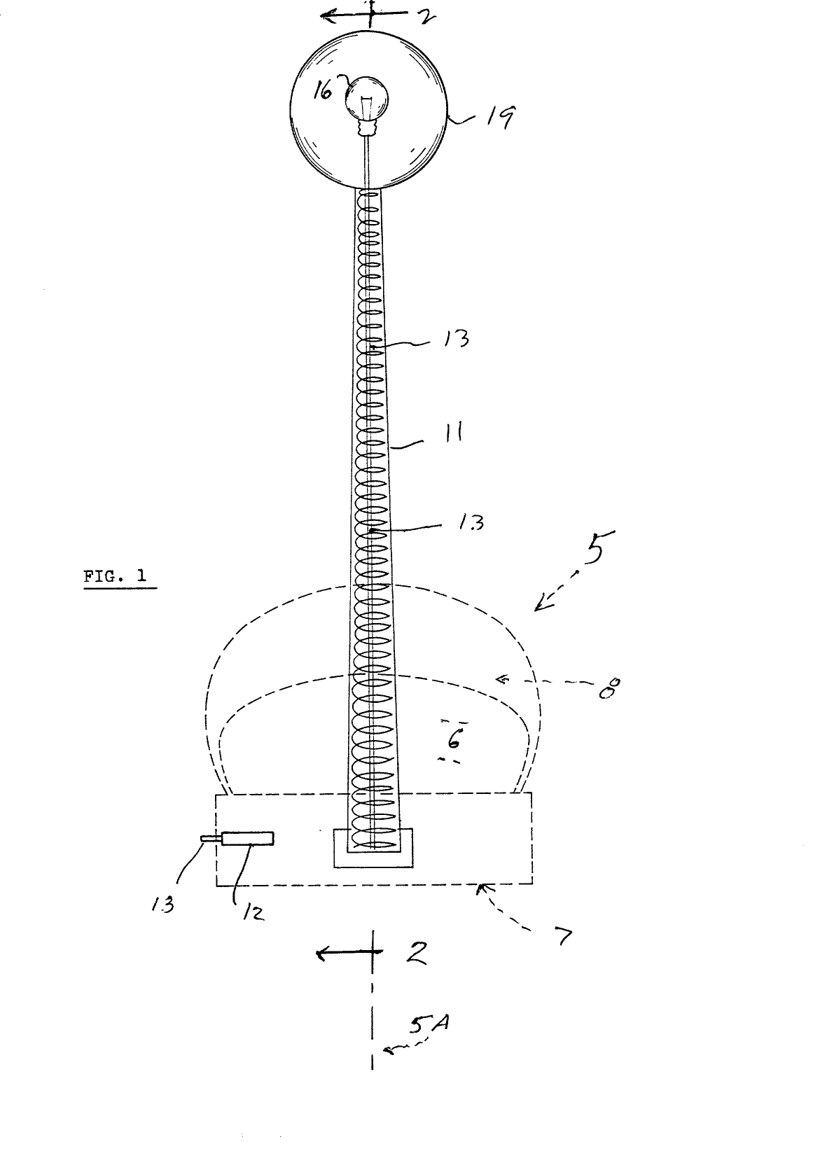

Drawing FIG. 1 is a rearward elevational view of a typically encounterable prior art walking shoe environment (5), herein environmentally depicted in phantom-lines, and as seen in solid lines, augmentally equipped with a representative embodiment (10) of the “lofty visual warning device concept” of the present invention; and

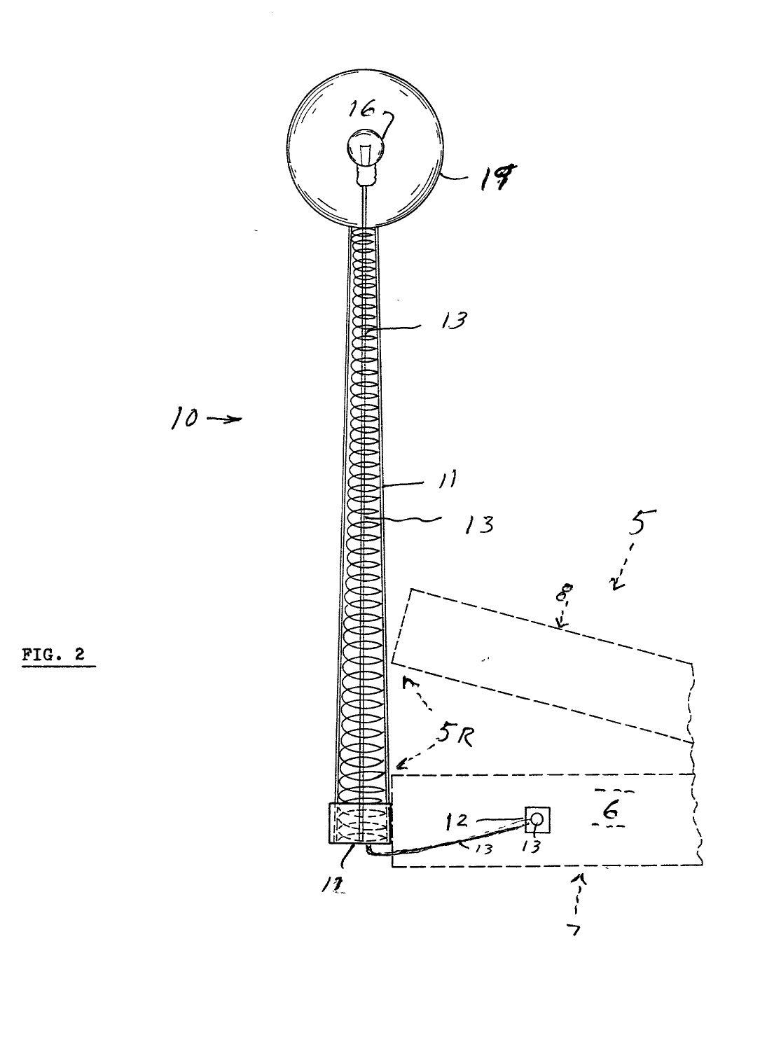

Drawing FIG. 2 is a sectional elevational view taken along line 2-2 of FIG. 1, and which section line 2-2 is synonymous with the prior art walking shoe (5) central upright-plane (5A).

### DETAILED DESCRIPTION OF THE DRAWING

As mentioned hereabove, phantom lines in drawing FIGS. 1 and 2 refer to a typical walking shoe environment (5) for the lofty warning devices concept of (e.g. 10) of the present invention. And for such typical walking shoes (e.g. 5), they typically extend directionally longitudinally forwardly from the walking shoe rear-end (5R) as a lower-base (6) having a lower-tread (7) and with a co-longitudinal foot-rest surface (8) thereabove.

The novel lofty warning devices (e.g. 10) for typical walking shoes (e.g. 5) essentially comprise one or more lofty and horizontally vibratory columns (preferably of helical construction) that are respectively attached to the walking shoe lower-base (5) and extending loftily therefrom and even loftily above the walking shoe foot-rest surface (8). Each such lofty and spring upright column (e.g. 11) topically carries a visually bright ornamental feature (e.g. 19). Such bright ornamental characteristic is alternatively provided by: some structurally inherent nature e.g. chemical phosphoresence: or alternatively, a chemical storage-battery (e.g. 12) having an electrically conductive stance with an incandescent bulb (e.g. 16) carried by the ornamental feature (19), In the latter event, electrical conduction between elements 12 and 16 might be alternatively provided by: a metallic (e.g. a helical) lofty upright column (11) that might be internally provided with an electrical-lead (13) or even wherein the entire upright column (11) itself is metallic and inherently electrically conductive. In the latter event, the entire column (11) might be helically metallic and predominately serve as the electrical conductor between the chemical storage-battery (12) and the lofty incandescent bulb(16).

From the foregoing, the construction and operation of the “lofty visual warning devices for walking shoes” of the present invention will be readily understood and further explanation believed to be unnecessary. However, since numerous modifications and changes will readily occur to those skilled in the art: it is not desired to limit the invention to the exact construction shown and described, and accordingly, all suitable modifications and equivalents may be resorted to, zs as falling within the scope of the appended claims.

What is claimed is as follows:

1. For the environment of a typical walking shoe that extends centrally and directionally longitudinally along an upright-plane and having in perpendicularly intersecting relationship to said upright plane, a horizontal lower-base extending directionally longitudinally forwardly from a rear-end thereof and having a generally horizontal lower-tread, and said lower-base being upwardly equipped with a directionally longitudinally extending foot-rest surface locatable at the lower-part of a foot-embraceable foot-embraceable sheath, the improvement comprising: rearwardly attached to the lower-base adjacent its rear-end and extending loftily and including loftily above the foot-rest surface, visual warning means comprising: at least one lofty and horizontally vibratory uprightcolumn and which respectively topically carry a visually bright ornamental fixture.

2. The aesthetically improved walking shoe of claim 1 wherein the at least one topically carried bright ornamental feature possesses a luminescent characteristic; and wherein such column is loftily helical.

3. The improved walking shoe of claim 2 wherein there is a plurality of said visual warning means, all being undrlyingly attached at a common-adapter located at a rearward portion of the walking shoe lower-base.

4. The structure of claim 2 wherein the topically carried carried ornamental feature takes the form of an incandescent bulb that is powered from a chemical storage-battery that is removably attached to the walking shoe lower-base nearby the rear-end thereof.

5. The structure of claim 4 wherein the at least one helical vibratory member is metallic and serves as electrical conductor between the chemical storage-battery and an incandescent bulb ornamental feature.

6. The structure of claim 5 wherein there is a plurality of said helical metallic vibratory members, all being attached through a common-adapter to a rearward portion of said walking shoe lower-base and in adjacent proximity to said removably positioned chemical storage-battery.

7. The structure of claim 4 wherein a flexible metallic wire, surrounded by a helical vibratory member, serves as an electrical conduit between the chemical storage battery and the at least one incandescent bulb.

8. The structure of claim 7 wherein there are plural pairs of flexible metallic wire and surrounding helical vibratory member, all said pairs being attached through a common-adapter to a rearward portion of said walking shoe lower-base and in adjacent proximity to said removably positioned chemical storage-battery.

9. The structure of claim 2 wherein the at least one visually bright topical ornamental feature is itself independently luminescent and without the need of non-natural electrical power.
